(19) United States
(12) Patent Application Publication
(10) Pub. No.: US 2001/0043784 A1
(43) Pub. Date: Nov. 22, 2001

(54) Picture quality adjustment method and picture quality adjustment apparatus

(76) Inventors: Yoshinari Shirata, Chiba (JP); Yoshiki Koura, Tokyo (JP); Masayoshi Miura, Chiba (JP)

Correspondence Address: William S. Frommer Esq., FROMMER LAWRENCE & HAUG LLP, 745 Fifth Avenue, New York, NY, 10151, US

(21) Appl. No.: 09/808,502

(22) Filed: Mar. 14, 2001

(30) Foreign Application Priority Data
Mar. 15, 2000 (JP) 2000-072328
Jan. 24, 2001 (JP) 2001-015505

(51) Int. Cl. H04N 9/79

(52) U.S. Cl. 386/21; 386/45

(57) ABSTRACT

A picture quality adjustment method is disclosed wherein, if a user performs a picture quality adjustment operation once, even if a picture quality adjustment operation is not performed any more for video software of the same authoring, genre or image characteristic, an image of an optimum picture quality can be obtained. When a disk ID of a disk to be played back is not stored in a first memory, it is discriminated whether or not characteristic describing information then and corresponding picture quality adjustment data are stored in a second memory. If such data are not stored, then the picture quality is set to a preset condition, but if such data are stored, then the picture quality adjustment data are read out and picture quality adjustment is executed. If the user instructs to store the picture quality adjustment data then after picture quality adjustment is performed or without performing picture quality adjustment, then the picture quality adjustment data then are written in a corresponding relationship to the disk ID and the characteristic describing information into the first memory and in a corresponding relationship to the characteristic describing information into the second memory. When the same disk is played back layer, the picture quality adjustment data corresponding to the disk are read out from the first memory to execute picture quality adjustment.

### BACKGROUND OF THE INVENTION

This invention relates to a picture quality adjustment method and a picture quality adjustment apparatus for a video outputting apparatus such as a DVD (Digital Versatile Disc) player or a set top box.

Where a video signal outputted from a video outputting apparatus such as a DVD player or a set top box is signaled to and displayed on a video display apparatus, in order to adjust the picture quality of an image to be displayed such as an average brightness or a brightness contrast, a method is conventionally employed wherein an adjustment operation is performed on the video display apparatus side to adjust the picture quality.

However, video software (contents) which is authored in various manners, belongs to various genres (categories) or has various image characteristics may be outputted from a video outputting apparatus such as a DVD player or a set top box.

Therefore, it is difficult to always obtain an image of an optimum picture quality by a single operation for adjustment of the picture quality on the video display apparatus side. Thus, the user must perform a picture quality adjustment operation every time the authoring, genre or image characteristic of video software to be outputted from the video outputting apparatus changes. Therefore, a heavy burden is imposed on the user in terms of the picture quality adjustment operation.

### SUMMARY OF THE INVENTION

It is an object of the present invention to provide a picture quality adjustment method and a picture quality adjustment apparatus wherein, if a user performs a picture quality adjustment operation once, even if a picture quality adjustment operation is not performed any more for video software of the same authoring, genre or image characteristic, an image of an optimum picture quality can be obtained while significantly decreasing the burden to the user in picture quality adjustment operation.

In order to attain the object described above, according to an aspect of the present invention, there is provided a picture quality adjustment method, comprising the steps of writing a picture quality adjustment condition for a video signal as picture quality adjustment data in a corresponding relationship to video identification information for specifying a video or characteristic describing information which describes an image characteristic into a memory which is capable of keeping storage contents thereof without a power supply or with a backup power supply, and reading out, upon outputting of a video, if the video identification information or the characteristic describing information of a video signal to be outputted and the corresponding picture quality adjustment data are stored in the memory, the picture quality adjustment data from the memory and setting a picture quality adjustment condition for the video signal to be outputted in accordance with the read out picture quality adjustment data.

According to another aspect of the present invention, there is provided a picture quality adjustment apparatus, comprising a memory capable of keeping storage contents thereof without a power supply or with a backup power supply, and a control section for writing a picture quality adjustment condition for a video signal as picture quality adjustment data in a corresponding relationship to video identification information for specifying a video or characteristic describing information which describes an image characteristic into the memory and reading out, upon outputting of a video, if the video identification information or the characteristic describing information of a video signal to be outputted and the corresponding picture quality adjustment data are stored in the memory, the picture quality adjustment data from the memory and setting a picture quality adjustment condition for the video signal to be outputted in accordance with the read out picture quality adjustment data.

With the picture quality adjustment method and the picture quality adjustment apparatus, if a user performs a picture quality adjustment operation once, then even if a picture quality adjustment operation is not performed any more for video software of the same authoring, genre or image characteristic, an image of an optimum picture quality can be obtained while significantly decreasing the burden to the user in picture quality adjustment operation.

It is to be noted that, where a video outputting apparatus is a video playback apparatus such as a DVD player which plays back, from a recording medium such as a disk, videos recorded on the recording medium, the video identification information above includes information for specifying the recording medium such as a disk ID (identification information), and generally is information which specifies a program, a genre or a scene.

If a disk has no disk ID recorded thereon, then header information of the disk is combined suitably in accordance with a predetermined rule such as a combination of the number of chapters included in the disk and a play time, and the combination is used as a disk ID of the disk.

Further, the characteristic describing information above is a description of image characteristic for each unit of images developed in a time series such as programs or scenes, and is hereinafter referred to as “metadata”.

The above and other objects, features and advantages of the present invention will become apparent from the following description and the appended claims, taken in conjunction with the accompanying drawings in which like parts or elements denoted by like reference symbols.

### BRIEF DESCRIPTION OF THE DRAWINGS

FIG. 1 is a block diagram showing a DVD player to which the present invention is applied;

FIG. 2 is a similar view but showing another DVD player to which the present invention is applied;

FIGS. 3 and 4 are flow charts illustrating an example of an adjustment processing routine performed by a system controller of the DVD player of FIG. 1 or 2;

FIGS. 5A and 5B are views illustrating an example of a storage condition of memories of the DVD player of FIG. 1 or 2;

FIG. 6 is a block diagram showing a digital TV receiver to which the present invention is applied; and

FIG. 7 is a similar view but showing another digital TV receiver to which the present invention is applied.

### DESCRIPTION OF THE PREFERRED EMBODIMENTS

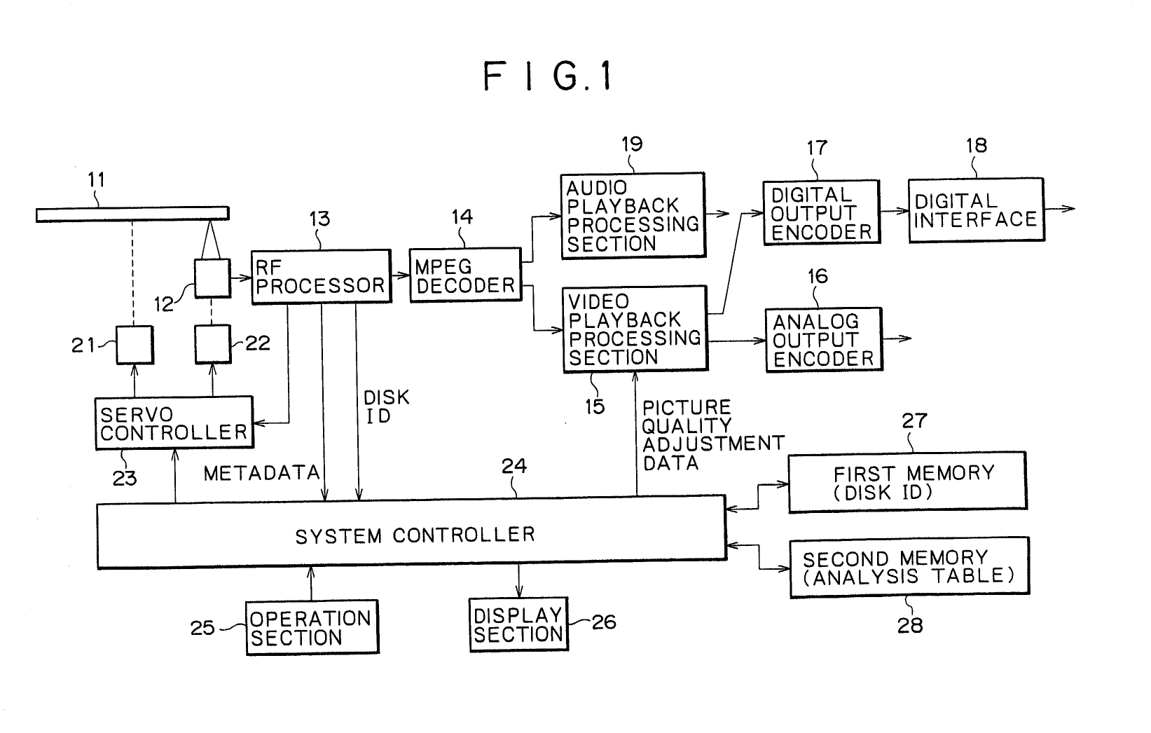

1. Embodiments wherein the invention is applied to a DVD player . . . FIGS. 1 to 5B

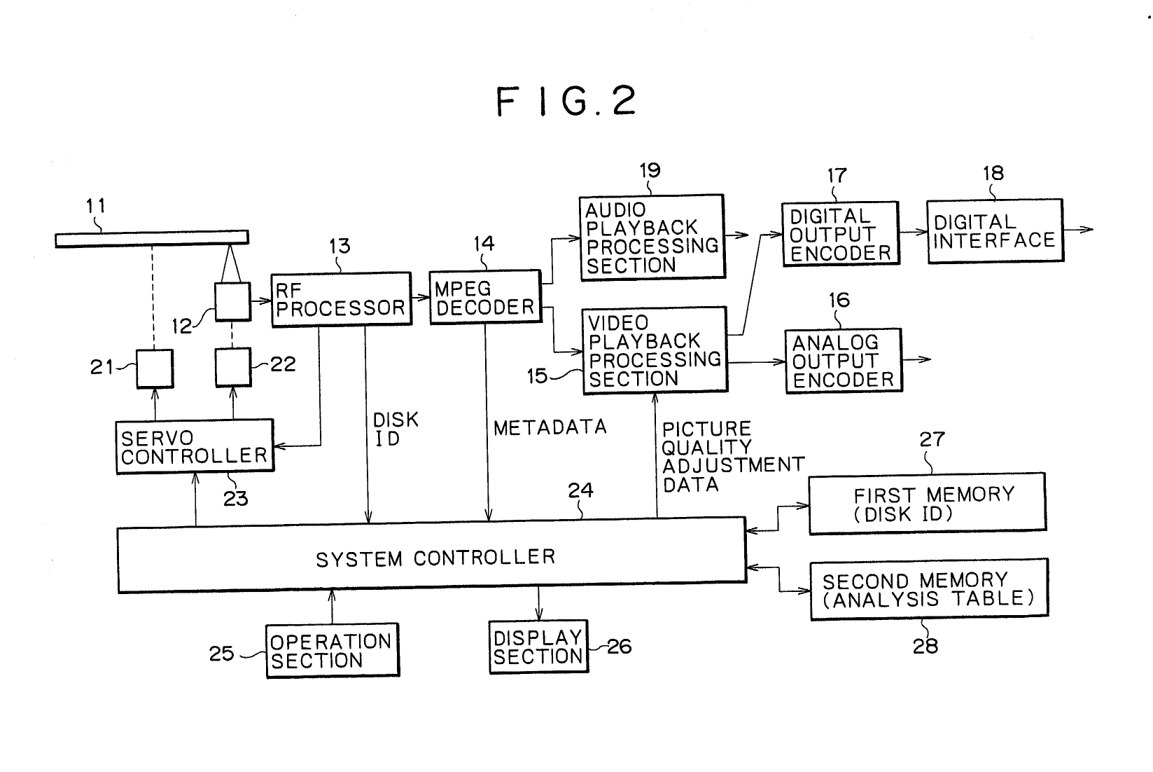

1-1. Outline of the player system . . . FIGS. 1 and 2

FIGS. 1 and 2 show different embodiments wherein the present invention is applied to a DVD player.

Referring to FIGS. 1 and 2, a video signal and an audio signal in a form compressed, coded and multiplexed in conformity with, for example, the MPEG (Moving Picture Experts Group) 2 standards and a disk ID are recorded on a disk 11.

It is to be noted that a plurality of pieces of video software (contents) may be recorded on the same disk. In this instance, video identification information (information for specifying videos) is different from the disk ID. However, the following description is given particularly of a case wherein such video identification information is a disk ID.

Such metadata as described hereinabove can be recorded on the disk 11, and in the present embodiments, it is assumed that metadata are recorded on some disks. FIG. 1 shows a DVD player for a disk on which metadata are recorded in a multiplexed condition separately from a video and audio data stream while FIG. 2 shows another DVD player for another disk on which metadata are recorded in a multiplexed form in and together with a video and audio data stream.

The metadata include data of an average brightness, a brightness contrast, a ratio between bright and dark regions, a brightness transition coefficient on a time series, a color balance, presence or absence of application of a visual effect and so forth as image characteristics. Where the metadata are recorded in a multiplexed form separately from a video and audio data stream, it describes image characteristics such as information representative of a section of video information, the lowest brightness in the section, the highest brightness, an average brightness and so forth. The information representative of a section is described with a presentation timestamp or the like.

The disk 11 is driven to rotate by a drive mechanism 21 which includes a disk motor and a driving circuit for the disk motor not shown. An optical head 12 is driven by a drive mechanism 22 which includes a feed motor and tracking and focusing actuators not shown. The drive mechanism 21 and 22 are controlled by a servo controller 23, which in turn is controlled by a system controller 24 which controls the entire player system.

An operation section 25 such as a remote controller is provided for the system controller 24 such that the user can perform adjustment of the picture quality of a playback image through the operation section 25. Also a display section 26 including a display unit such as a liquid crystal display device not shown is provided for the system controller 24.

A first memory 27 and a second memory 28 are connected to the system controller 24. Each of the first memory 27 and the second memory 28 is formed from an EAROM (Electrically Alterable Read Only Memory) or a flash memory and can keep stored contents thereof without using a power supply or through the use of a backup power supply. Picture quality adjustment data can be written in a corresponding relationship to a disk ID in the first memory 27 while the picture quality adjustment data can be written in a corresponding relationship to metadata in the second memory 28. The first memory 27 and the second memory 28 may be two memories physically separate from each other or two different areas of one memory.

Alternatively, each or both of the first memory 27 and the second memory 28 may be an external storage medium such as a memory card. Where an external storage medium is used, by using different external storage media depending upon whether a CRT display unit or a liquid crystal projector display unit is used as a video display apparatus, the video display apparatus having different display characteristics can be selectively used appropriately. Also it is possible to prepare in advance an external storage medium in which picture quality adjustment data and metadata produced with a displaying performance of a video display apparatus taken into consideration are written.

Information read from the disk 11 and outputted from the optical head 12 is supplied to a radio frequency (RF) processor 13. The RF processor 13 includes a generation section for generating a tracking error signal and a focusing error signal, an error correction section, a buffer section, a data stream detection and separation section, and a metadata detection and separation section not shown. Thus, a disk ID, a tracking error signal and a focusing error signal, and a video and audio data stream of the MPEG 2 standards are obtained from the RF processor 13.

Where the metadata are in the multiplexed form separately from a video and audio data stream, the metadata are detected and separated by the RF processor 13 and fetched by the system controller 24 as seen from FIG. 1.

It is to be noted that, where caption data are multiplexed, they are detected and separated by the RF processor 13 and are played back by a caption playback section not shown and then superimposed with the video signal by a video playback processing section 15 which is hereinafter described.

The disk ID is fetched by the system controller 24. The tracking error signal and the focusing error signal are supplied to the servo controller 23, by which they are used for tracking servo control and focusing servo control of the optical head 12.

The video and audio data stream from the RF processor 13 is separated into a video data stream and an audio data stream and then decompressed and decoded into video data and audio data by an MPEG decoder 14.

Where the video and audio data stream has metadata multiplexed therein, the metadata are demultiplexed from the video and audio data stream by the MPEG decoder 14 and fetched by the system controller 24 as seen in FIG. 2.

The video data are outputted from the MPEG decoder 14 and separated into brightness data and color difference data by the video playback processing section 15. The video playback processing section 15 further performs picture quality adjustment processing for the thus separated brightness data or color difference data and then synthesizes the brightness data and the color difference data to obtain video data of the same format as that of the video data inputted to the video playback processing section 15.

The picture quality in this instance includes, for the brightness, the lowest brightness, the highest brightness, an average brightness, a brightness contrast, and a contour emphasis (contour compensation) characteristic and, for the color, a color gain (color concentration), a hue and so forth.

The video data outputted from the video playback processing section 15 are converted on one hand into an analog video signal of the NTSC system, the PAL system or the progressive system by an analog output encoder 16. The analog video signal obtained is outputted to a video display apparatus such as a CRT display apparatus or a liquid crystal projector display apparatus not shown, an analog video and audio apparatus such as an analog TV (Television) receiver or some other analog video apparatus not shown.

The video data outputted from the video playback processing section 15 are on the other hand outputted, after they are converted into video data of some other format by a digital output encoder 17 or without undergoing such conversion, to a digital video and audio apparatus such as a digital TV receiver or some other digital video apparatus not shown through a digital interface 18 such as an interface complying with the IEEE (Institute of Electrical and Electronics Engineers) 1394 standards.

The audio data outputted from the MPEG decoder 14 are subject to audio playback processing by an audio playback processing section 19. Though not shown, in conformity with the video data outputted from the video playback processing section 15, the audio data outputted from the audio playback processing section 19 are on one hand converted into an analog audio signal and outputted to an audio outputting apparatus such as a speaker apparatus or a headphone apparatus, an analog video and audio apparatus such as an analog TV receiver or some other analog audio apparatus not shown, and on the other hand outputted through the digital interface 18 after multiplexed with the video data after converted into audio data of some other format or without undergoing such conversion or through another digital interface not shown without being multiplexed with the video data to a digital video and audio apparatus such as a digital TV receiver or some other digital audio apparatus not shown.

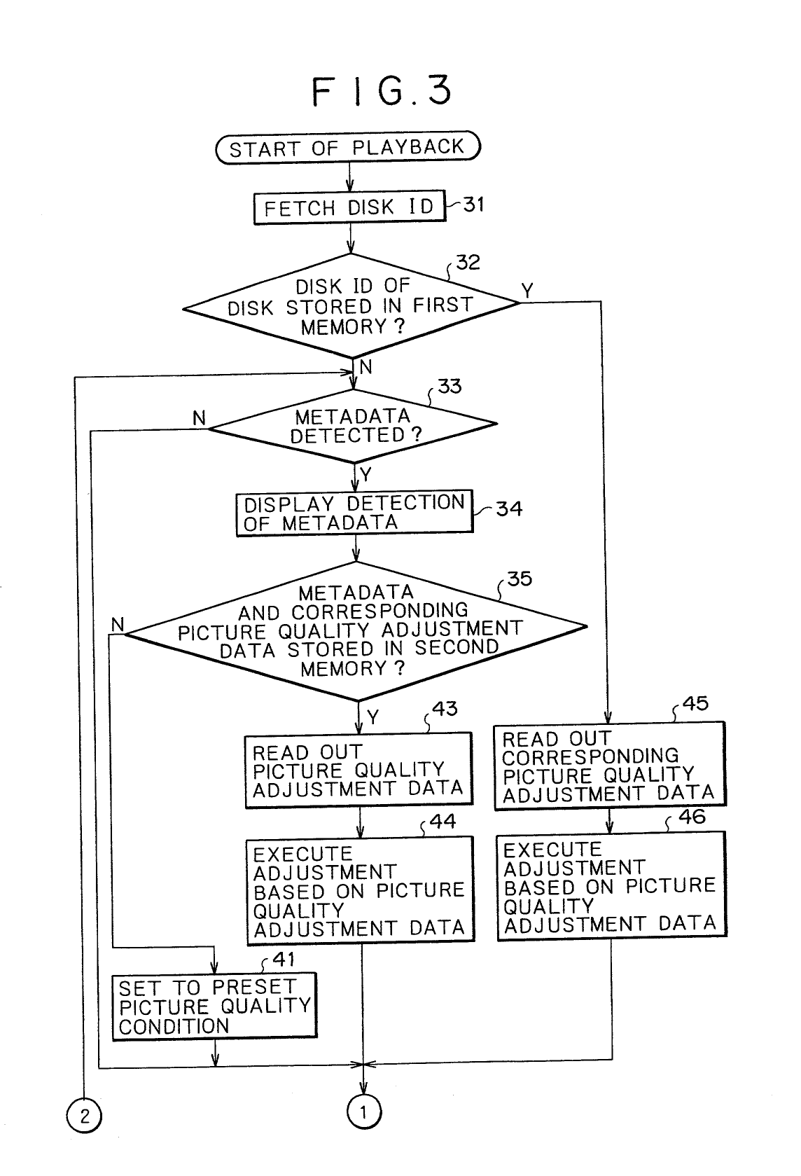

1-2. Picture quality adjustment . . . FIGS. 3 to 5B

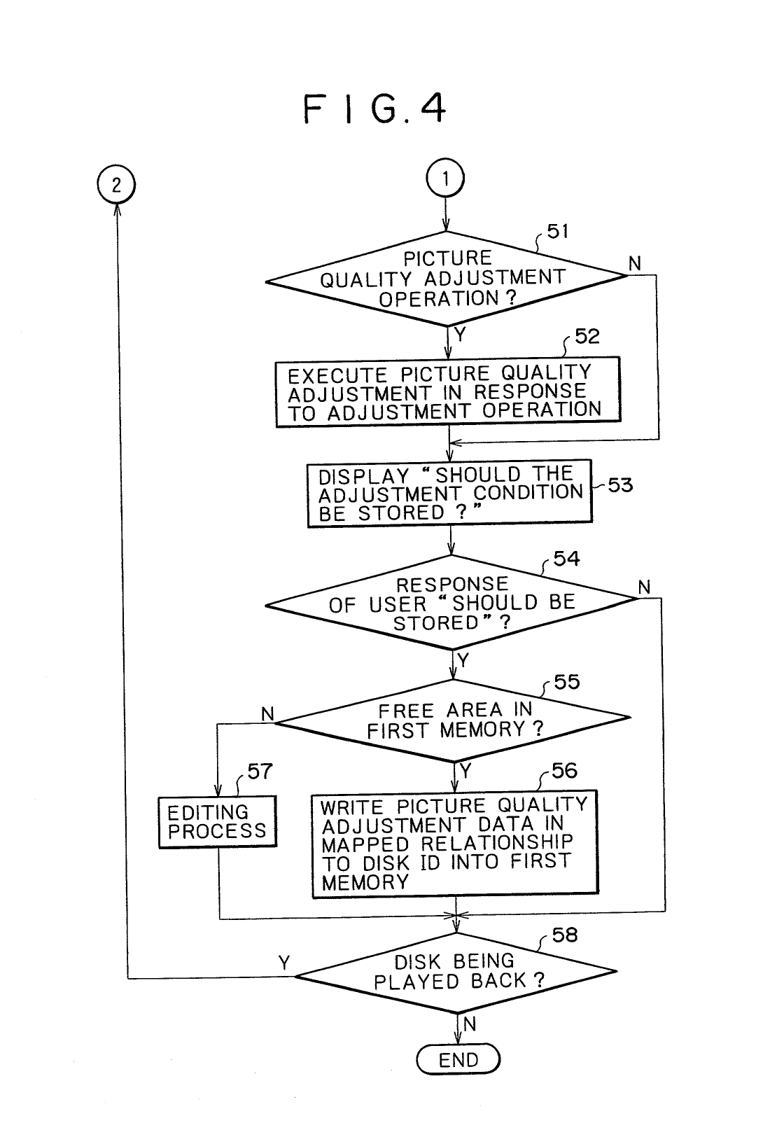

The player system of FIG. 1 or 2 having such a construction as described above performs picture quality adjustment, for example, in accordance with an adjustment process routine illustrated in FIGS. 3 and 4 while a playback image is displayed on an image display apparatus not shown connected to the player system.

In particular, in the adjustment process routine illustrated in FIGS. 3 and 4, after playback of a certain disk is started, the system controller 24 first fetches the disk ID of the disk in step 31 illustrated in FIG. 3. If the disk does not have a disk ID recorded thereon, then header information of the disk is combined in accordance with a predetermined rule to produce a disk ID for the disk as described hereinabove.

Then in step 32, the system controller 24 discriminates whether or not the disk ID is stored in the first memory 27. When the disk of the disk ID is played back for the first time, the first memory 27 does not have the disk ID stored therein.

If the disk ID is not stored in the first memory 27, then the processing advances from step 32 to step 33, in which the system controller 24 discriminates whether or not metadata are detected. If metadata are not detected, then the processing advances from step 33 to step 51 directly without performing adjustment of the picture quality of the playback image.

However, if metadata are detected in step 33, then the processing advances from step 33 to step 34, in which the system controller 24 controls the display section 26 to display to inform the user that metadata are detected. Then, the processing advances to step 35, in which the system controller 24 discriminates whether or not the metadata then and picture quality adjustment data corresponding to the metadata are stored in the second memory 28.

If the metadata then and the corresponding picture quality adjustment data are not stored in the second memory 28, then the processing advances from step 35 to step 41, in which the system controller 24 sets the picture quality of the playback image to a picture quality set in advance, for example, to a picture quality in a state wherein no picture quality adjustment is performed for brightness data and color difference data by the video playback processing section 15. Thereafter, the processing advances to step 51.

On the contrary if the metadata then and the corresponding picture quality adjustment data are stored in the second memory 28 in step 35, then the processing advances from step 35 to step 43, in which the system controller 24 reads out the picture quality adjustment data corresponding to the metadata then from the second memory 28. Then, the processing advances to step 44, in which the system controller 24 executes picture quality adjustment in accordance with the thus read out picture quality adjustment data. Thereafter, the processing advances to step 51.

If the disk ID fetched or produced in step 31 is stored in the first memory 27 in step 32, then the processing advances from step 32 to step 45, in which the system controller 24 reads out the picture quality adjustment data corresponding to the disk ID from the first memory 27. Thereafter, the processing advances to step 46, in which the system controller 24 executes picture quality adjustment in accordance with the thus read out picture quality adjustment data. Then, the processing advances to step 51.

Referring now to FIG. 4, in step 51, the system controller 24 discriminates whether or not a picture quality adjustment operation is performed by the user.

The user can perform adjustment or alteration of the picture quality through a picture quality adjustment operation of the operation section 25 not only when the picture quality of the playback image is not adjusted because no metadata are detected but also when the picture quality of the playback image is not set to the picture quality condition set in advance in step 41, when picture quality adjustment is performed in accordance with the picture quality adjustment data corresponding to the metadata stored in the second memory 28 in step 44 or when picture quality adjustment is performed in accordance with the picture quality adjustment data corresponding to the disk ID stored in the first memory 27 in step 46.

Then, when the user performs a picture quality adjustment operation, the system controller 24 advances the processing from step 51 to step 52, in which it alters the picture quality adjustment data in response to the adjustment operation of the user and executes picture quality adjustment in accordance with the adjustment operation of the user. Thereafter, the processing advances to step 53. On the other hand, if the user does not perform a picture quality adjustment operation in step 51, then the processing advances from step 51 to step 53 directly.

In step 53, the system controller 24 controls the display section 26 to display for inquiry to the user of whether or not the picture quality adjustment condition then should be stored as a picture quality adjustment condition corresponding to the disk or a picture quality adjustment condition corresponding to the metadata then.

Not only when a picture quality adjustment operation is performed but also when a picture quality adjustment operation is not performed, the user can store the picture quality adjustment condition then as picture quality adjustment condition corresponding to the disk or a picture quality adjustment condition corresponding to the metadata then. If the user wants to store the picture quality adjustment condition then, it will perform an operation therefor, but otherwise, it will perform an operation therefor.

Then, the processing advances from step 53 to step 54, in which the system controller 24 discriminates whether or not the response of the user represents the storage. If the response represents the storage, then the processing advances from step 54 to step 55, in which the system controller 24 discriminates whether or not the first memory 27 has some free or unoccupied area. If the first memory 27 has some free area, then the processing advances from step 55 to step 56, in which the system controller 24 writes the picture quality adjustment data then in a corresponding relationship to the disk ID of the disk into the first memory 27. Thereafter, the processing advances to step 58.

In this instance, if metadata are detected, then the system controller 24 writes the picture quality adjustment data then in a corresponding relationship not only to the disk ID but also to the metadata into the first memory 27 and further writes the picture quality adjustment data then in a corresponding relationship to the metadata into the second memory 28.

On the other hand, if the picture quality adjustment data are already stored in a corresponding relationship to the disk ID in the first memory 27, then the system controller 24 rewrites the picture quality adjustment data. Further, if the picture quality adjustment data are stored in a corresponding relationship to the metadata in the second memory 28, then the system controller 24 rewrites the picture quality adjustment data.

If the first memory 27 does not have a free area in step 55, then the processing advances from step 55 to step 57, in which an editing process is executed, whereafter the processing advances to step 58.

The editing process in step 57 may be to erase those ones of disk IDs and corresponding picture quality adjustment data stored in the first memory 27 which were registered oldest and store the disk ID then and the corresponding picture quality adjustment data or to erase the oldest disk ID and corresponding picture quality adjustment data and determine whether or not the disk ID then and the corresponding picture quality adjustment data should be stored in accordance with selection of the user.

On the other hand, if it is discriminated in step 54 that the response of the user does not represent an intention of the storage, then the processing advances from step 54 to step 58 directly.

The user may not intend storage of the picture quality adjustment condition, for example, when the disk 11 is played back temporarily using a liquid crystal projector display apparatus as the video display apparatus in place of a CRT display apparatus and the user does not want that the picture quality adjustment state set and stored for the normally used CRT display apparatus is altered.

In step 58, it is discriminated whether or not the disk is being played back. If the disk is being played back, then the processing returns from step 58 to step 33 so that the processing beginning with step 33 is repeated. If the playback of the disk comes to an end, then the adjustment process is ended as well.

It is to be noted that, for a user who considers that it is cumbersome to respond to the display (inquiry) in step 53 whether or not the picture quality adjustment condition then should be stored every time, the adjustment process routine to be executed by the system controller 24 may be set otherwise such that the discrimination in step 54 normally is to store the picture quality adjustment condition then.

As an example, it is assumed that, when the first memory 27 and the second memory 28 have no picture quality adjustment data stored therein, a disk of the disk ID of “D1” on which metadata M1 and M2 representative of image characteristics for two video scenes are recorded is played back first.

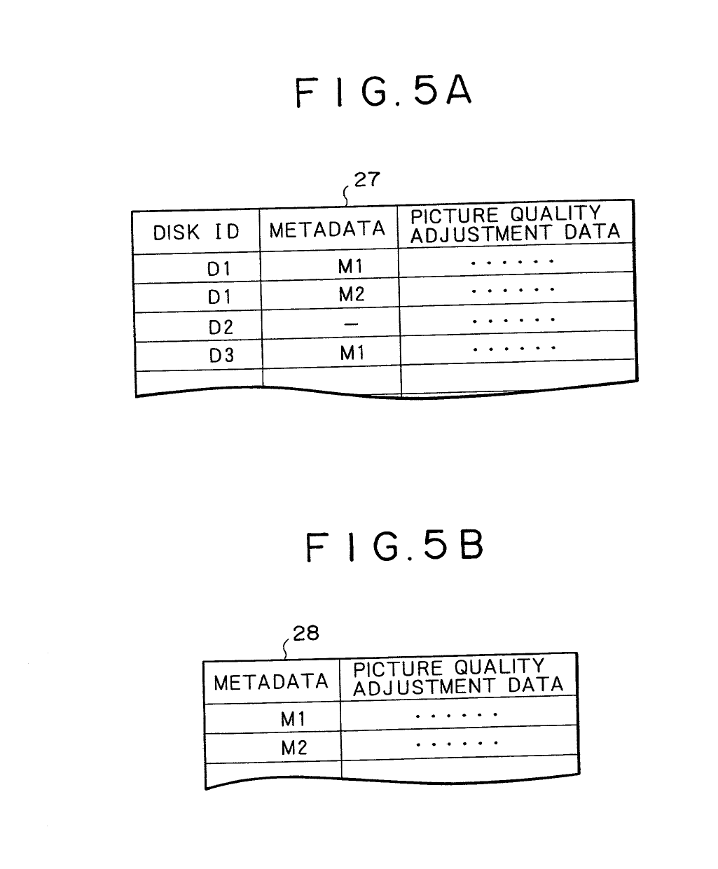

At this instance, for example, if the image characteristic of the video scene whose image characteristic is indicated by the metadata M1 is that “the average brightness is high” and the user adjusts the picture quality so as to lower the average brightness whereas the image characteristic of the video scene whose image characteristic is indicated by the metadata M2 is that “the brightness contrast is low” and the user adjusts the picture quality so as to raise the brightness contrast and then the user issues an instruction to store the individual picture quality adjustment data then, then the individual picture quality adjustment data are written in a corresponding relationship to the disk ID “D1” and in a corresponding relationship to the metadata M1 and M2 into the first memory 27 as seen in FIG. 5A and further the individual picture quality adjustment data are written in a corresponding relationship to the metadata M1 and M2 into the second memory 28 as seen in FIG. 5B.

It is assumed that, in this state, another disk of the disk ID of “D2” on which no metadata is recorded is played back subsequently. At this time, if the user adjusts the picture quality and issues an instruction to store the adjustment data then, then the picture quality adjustment data then are written in a corresponding relationship to the disk ID “D2” into the first memory 27 as seen in FIG. 5A.

Then, it is assumed that a further disk of the disk ID of “D3” on which metadata M1 indicative of an image characteristic for a certain video scene is played back subsequently. The metadata M1 and the corresponding picture quality adjustment data are already stored in the second memory 28. Accordingly, at this time, picture quality adjustment of the video scene whose image characteristic is indicated by the metadata M1 is executed in step 44 in accordance with the picture quality adjustment data corresponding to the metadata M1 read out from the second memory 28.

On the other hand, if the user issues an instruction to store the picture quality adjustment data then without performing picture quality adjustment or after it performs picture quality adjustment, then the picture quality adjustment data are written in a corresponding relationship to the disk ID “D3” and also in a corresponding relationship to the metadata M1 into the first memory 27 as seen in FIG. 5A, and the picture quality adjustment data corresponding to the metadata M1 stored in the second memory 28 are rewritten with the picture quality adjustment data then as seen in FIG. 5B.

Thereafter, if the disk of the disk ID of “D1” on which the metadata M1 and M2 are recorded is played back, then picture quality adjustment of the video scene whose image characteristic is indicated by the metadata M1 is executed in step 46 in accordance with the picture quality adjustment data read out from the first memory 27 and corresponding to the disk ID “D1” and the metadata M1. Meanwhile, picture quality adjustment of the video scene whose image characteristic is indicated by the metadata M2 is executed in step 46 in accordance with the picture quality adjustment data read out from the first memory 27 and corresponding to the disk ID “D1” and the metadata M2.

In the player system of FIG. 1 or 2 described above, when a user performs an operation to store picture quality adjustment data, picture quality adjustment data then are written into the first memory 27 in a corresponding relationship to the disk ID and further in a corresponding relationship to metadata then. Then, when the disk is to be played back thereafter, the picture quality adjustment data corresponding to the disk and corresponding to metadata then are read out from the first memory 27 and a picture quality adjustment condition is set in accordance with the picture quality adjustment data. Consequently, the user can obtain a playback image of an optimum picture quality from the same disk without performing a picture quality adjustment operation in a unit of a video every time playback is to be performed.

Further, the picture quality adjustment data are written in a corresponding relationship to the metadata into the second memory 28 in accordance with an operation history of the user. Then, when the disk on which the same metadata are recorded is to be played back later, picture quality adjustment data corresponding to the metadata are read out to set a picture quality adjustment condition. Consequently, the user can obtain a playback image of an optimum picture quality from the disk on which the same metadata are recorded without performing a picture quality adjustment operation every time playback is to be performed.

1-3. Another example of the first memory

In the player system of FIG. 1 or 2, if it is intended to store a disk ID and corresponding picture quality adjustment data of a large number of disks into the first memory 27, then a memory having a large capacity is required for the first memory 27 or such an editing process as described hereinabove is required.

Thus, if the disk 11 is of the recordable type or the rewritable type, then part of the area of the disk 11 may be utilized as the first memory. In this instance, although a circuit for writing picture quality adjustment data is required, the system controller 24 may be constructed so as to store picture quality adjustment data for a disk to be played back into an internal RAM such that, when the user performs an operation to store picture quality adjustment data, picture quality adjustment data then are written into the area of the disk 11 which is utilized as the first memory, and then when the same disk is to be played back, the picture quality adjustment data are fetched together with the disk ID from the disk and stored into the internal RAM.

1-4. A further example of the first memory

According to the first memory 27 shown in FIG. 5A, metadata are not recorded on the disk whose disk ID is “D2”, and the disk ID “D2” and corresponding picture quality adjustment data are stored without being made correspond to metadata into the first memory 27. For a disk on which metadata are not recorded in this manner, the first memory 27 can be used in the following manner.

It is presumed that, with the disk whose disk ID is “D2”, it is necessary to change the picture quality between a plurality of sections such as a front half section and a rear half section. In this instance, the system controller 24 produces information pieces T1, T2 and so on representative of individual sections based on information of a presentation timestamp and so forth and writes picture quality adjustment data C1, C2 and so on of the individual sections in a corresponding relationship to the information pieces T1, T2 and so on in place of metadata into the first memory 27.

Then, when the same disk is to be played back, since the information pieces T1, T2 and so on representative of the individual sections are recorded in the metadata describing column for the disk whose disk ID in the disk ID describing column in the first memory 27 is D2, the system controller 24 detects the individual sections and executes picture quality adjustment in the individual sections in accordance with the corresponding picture quality adjustment data C1, C2 and so on.

Where the first memory of the construction described above is used, even when a disk on which metadata are not recorded is to be played back, the picture quality adjustment condition can be changed over automatically in a plurality of sections.

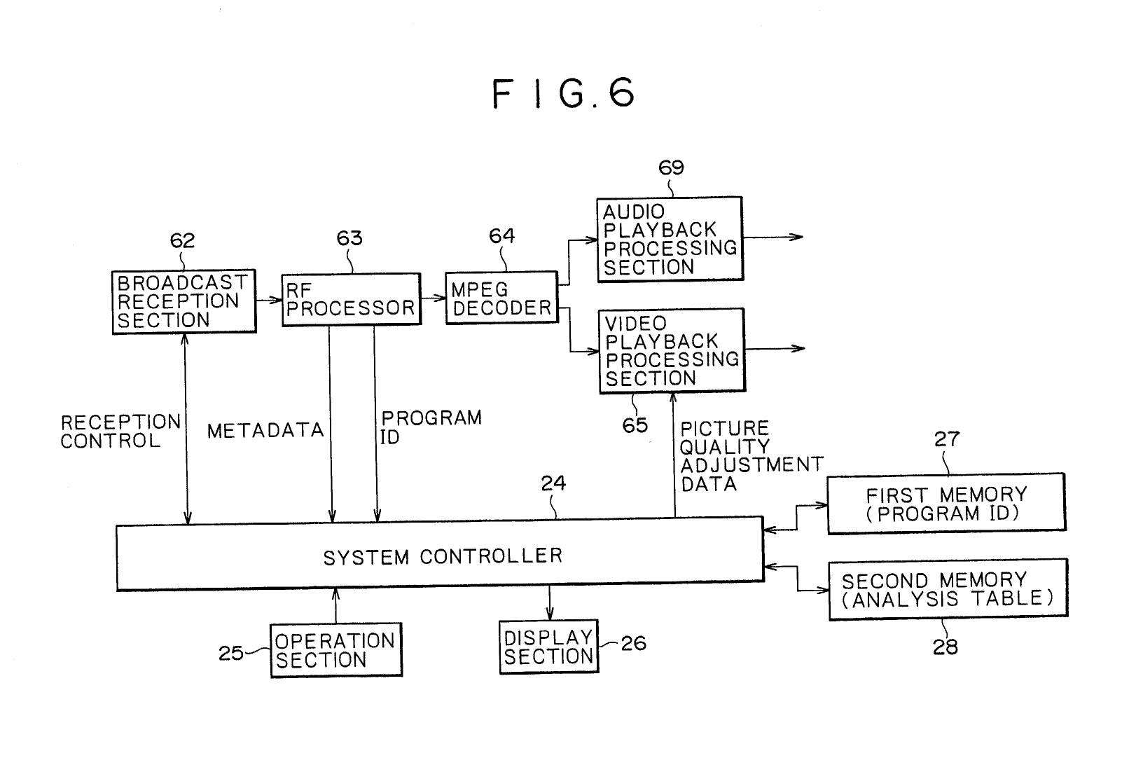

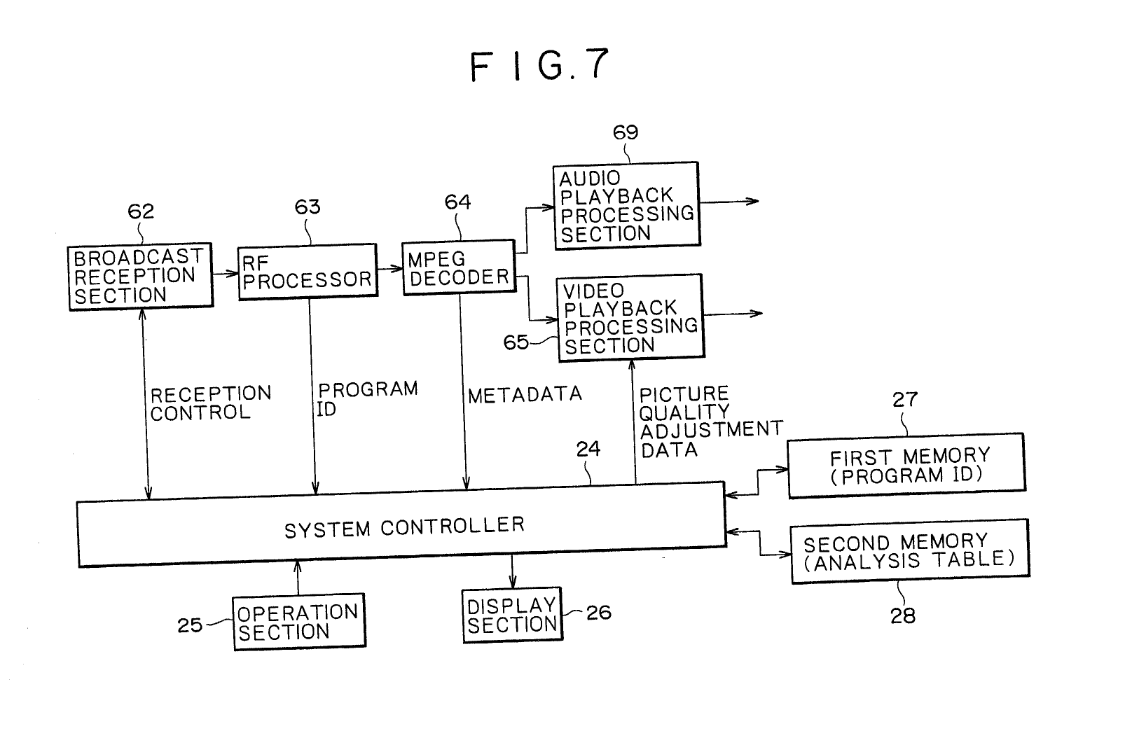

2. Other embodiments . . . FIGS. 6 and 7

A picture quality adjustment method of the present invention can be applied not only to a video playback apparatus such as a DVD player but also to a video outputting apparatus such as a TV receiver.

Also in TV broadcasting, video software (contents) which is authored in various manners, belongs to various genres or has various image characteristics is broadcast. Particularly in digital TV broadcasting, a program ID, a genre ID or the like is transmitted, and characteristic describing information (metadata) can be inserted into and transmitted together with a program or a scene.

FIGS. 6 and 7 show embodiments wherein the present invention is applied to a digital TV receiver. Particularly, FIG. 6 shows an embodiment wherein metadata are multiplexed and broadcast separately from a video and audio data stream, and FIG. 7 shows another embodiment wherein metadata are multiplexed into and broadcast together with a video and audio data stream.

Referring to FIGS. 6 and 7, a broadcast reception section 62 receives and selects a broadcast digital TV signal under the reception control of a system controller 24 in accordance with an operation by an operation section 25. The received and selected signal is supplied to a RF processor 63. The RF processor 63 includes a demodulation section, an error correction section, a data stream detection and separation section and a metadata detection and separation section not shown. Thus, a program ID (or genre ID) and a video and audio data stream of the MPEG system are obtained from the RF processor 63.

Where metadata are multiplexed separately from a video and audio data stream, the metadata are detected and separated by the RF processor 63 and fetched by the system controller 24 as seen in FIG. 6.

The program ID (or genre ID) is fetched by the system controller 24. The video and audio data stream from the RF processor 63 is separated into a video data stream and an audio data stream and then decompressed and decoded into video data and audio data by an MPEG decoder 64.

On the other hand, where the metadata are multiplexed in the video and audio data stream, the metadata are separated from the video and audio data stream and fetched by the system controller 24 as seen in FIG. 7.

The video data outputted from the MPEG decoder 64 are separated into brightness data and color difference data by a video playback processing section 65. The video playback processing section 65 further performs a picture quality adjustment process for the thus separated brightness data or color difference data and then synthesizes the brightness data and the color difference data to obtain video data of a format same as that of the video data inputted to the video playback processing section 65. The video data outputted from the video playback processing section 65 are converted into an analog video signal of the NTSC system or like.

The audio data outputted from the MPEG decoder 64 undergo an audio playback process and then are converted into an analog audio signal by an audio playback processing section 69.

Also each of the digital TV receivers described above with reference to FIGS. 6 and 7 includes the first memory 27 and the second memory 28, and picture quality adjustment data are written in a corresponding relationship to a program ID (or genre ID) into the first memory 27. Then, when a program in which the same program ID (or genre ID) is inserted is received next, the picture quality adjustment data corresponding to the program ID (or genre ID) are read out from the first memory 27 to set a picture quality adjustment condition. On the other hand, the picture quality adjustment data are written in a corresponding relationship to metadata into the second memory 28, and then when a program or a scene in which the same metadata are inserted is received next, the picture quality adjustment data corresponding to the metadata are read out from the second memory 28 to set a picture quality adjustment condition.

Metadata relating to a program or a scene may be information such as an average brightness, a color gain or a hue or may be an identification code indicative of an image pickup object such as a night view, fireworks or a clear sky.

It is to be noted that the present invention can be applied not only to a TV receiver but also to a set top box which receives a digital TV signal recorded on a hard disk, a magnetic disk or a like medium through a digital interface such as an interface of the IEEE 1394 standards and decodes the received digital TV signal.

While preferred embodiments of the present invention have been described using specific terms, such description is for illustrative purposes only, and it is to be understood that changes and variations may be made without departing from the spirit or scope of the following claims.

What is claimed is:

1. A picture quality adjustment method, comprising the steps of:
writing a picture quality adjustment condition for a video signal as picture quality adjustment data in a corresponding relationship to video identification information for specifying a video or characteristic describing information which describes an image characteristic into a memory which is capable of keeping storage contents thereof without a power supply or with a backup power supply; and
reading out, upon outputting of a video, if the video identification information or the characteristic describing information of a video signal to be outputted and the corresponding picture quality adjustment data are stored in said memory, the picture quality adjustment data from said memory and setting a picture quality adjustment condition for the video signal to be outputted in accordance with the read out picture quality adjustment data.

2. A picture quality adjustment method according to claim 1, wherein said memory is composed of a first memory and a second memory physically or regionally separate from each other and the picture quality adjustment data are written in a corresponding relationship to the video identification information into said first memory while the picture quality adjustment data are written in a corresponding relationship to the characteristic describing information into said second memory, and then upon outputting of an image, if the video identification information of a video signal to be outputted and the corresponding picture quality adjustment data are not stored in said first memory and the characteristic describing information and the corresponding picture quality adjustment data are stored in said second memory, then the picture quality adjustment data corresponding to the characteristic describing information are read out from said second memory and a picture quality adjustment condition for the video signal to be outputted is set in accordance with the read out picture quality adjustment data.

3. A picture quality adjustment method according to claim 1, wherein said memory is part of an area of a recording medium from which the video signal is to be played back.

4. A picture quality adjustment apparatus, comprising:
a memory capable of keeping storage contents thereof without a power supply or with a backup power supply; and
a control section for writing a picture quality adjustment condition for a video signal as picture quality adjustment data in a corresponding relationship to video identification information for specifying a video or characteristic describing information which describes an image characteristic into said memory and reading out, upon outputting of a video, if the video identification information or the characteristic describing information of a video signal to be outputted and the corresponding picture quality adjustment data are stored in said memory, the picture quality adjustment data from said memory and setting a picture quality adjustment condition for the video signal to be outputted in accordance with the read out picture quality adjustment data.

5. A picture quality adjustment apparatus according to claim 4, wherein said memory is composed of a first memory and a second memory physically or regionally separate from each other, and said control section writes the picture quality adjustment data in a corresponding relationship to the video identification information into said first memory and writes the picture quality adjustment data in a corresponding relationship to the characteristic describing information into said second memory, and then reads out, upon outputting of an image, if the video identification information of a video signal to be outputted and the corresponding picture quality adjustment data are not stored in said first memory and the characteristic describing information and the corresponding picture quality adjustment data are stored in said second memory, the picture quality adjustment data corresponding to the characteristic describing information from said second memory and sets a picture quality adjustment condition for the video signal to be outputted in accordance with the read out picture quality adjustment data.

6. A picture quality adjustment apparatus according to claim 4, wherein said memory is part of an area of a recording medium from which the video signal is to be played back.

7. A video outputting apparatus, comprising a picture quality adjustment apparatus according to any one of claims 1 to 3 or a picture quality adjustment apparatus according to any one of claims 4 to 6 as a video processing section.

8. A video outputting apparatus according to claim 7, wherein said image processing section demultiplexes digital video data, in which brightness data and color difference data are multiplexed, to obtain the brightness data and the color difference data and performs a picture quality adjustment process for at least one of the brightness data and the color difference data.
